(19) United States
(12) Patent Application Publication
(10) Pub. No.: US 2026/0079047 A1
(43) Pub. Date: Mar. 19, 2026

(54) COMPACT, HIGH-RESOLUTION SNAPSHOT HYPERSPECTRAL IMAGING WITH 3D PRINTED GLASS LIGHTGUIDE ARRAY

(71) Applicant: Arizona Board of Regents on Behalf of the University of Arizona, Tucson, AZ (US)

(72) Inventors: Rongguang LIANG, Tucson, AZ (US); Zhihan HONG, Tucson, AZ (US); Piaoran YE, Tucson, AZ (US); Douglas LOY, Tucson, AZ (US); Yuanyuan SUN, Tucson, AZ (US)

(21) Appl. No.: 19/110,763

(22) PCT Filed: Sep. 11, 2023
(86) PCT No.: PCT/US2023/073853

§ 371 Date: Mar. 11, 2025

Related U.S. Application Data
(60) Provisional application No. 63/375,341, filed on Sep. 12, 2022.

(51) Int. Cl. G01J 3/02

(52) U.S. Cl. CPC G01J 3/0218; G01J 3/0208; G01J 3/0216

(57) ABSTRACT

High-resolution compact snapshot hyperspectral imaging devices and methods for producing such devices are described. One example lightguide array device includes a plurality of lightguides configured as a three-dimensional structure having an input and an output end. Each lightguide extends from the input end to the output end and has an input facet that receives light and an output facet. The input facets of the lightguides form a first two-dimensional array at the input end of the three-dimensional structure with no spacing or a first spacing between each of the lightguides. The output facets of the lightguides form a second two-dimensional array at the output end of the three-dimensional structure with a second spacing between each of the lightguides that is larger than the spacing of the first three-dimensional array. At least one of the input end or the output end is shaped as a curved surface.

### CROSS-REFERENCE TO RELATED APPLICATION(S)

This application claims priority to the provisional application with Ser. No. 63/375,341 titled “COMPACT, HIGH-RESOLUTION SNAPSHOT HYPERSPECTRAL IMAGING WITH 3D PRINTED GLASS LIGHTGUIDE ARRAY,” filed Sep. 12, 2022. The entire contents of the above noted provisional application are incorporated by reference as part of the disclosure of this document.

### TECHNICAL FIELD

The disclosed technology relates to lightguide devices and methods for producing the same.

### BACKGROUND

Snapshot hyperspectral imaging is an emerging imaging modality to obtain spectral information of a dynamic target in real time. A number of snapshot hyperspectral imaging technologies have been developed for various applications ranging from astronomy to agriculture and medical applications. These technologies include integral field imaging, image mapping, multi-aperture filtering, spectrally resolving detector array, coded aperture, computed tomography imaging, tunable echelle imager, and Fourier transform spectral imaging. However, the current implementation of these techniques suffer from many disadvantages and shortcomings.

### SUMMARY

The disclosed embodiments overcome the deficiencies of prior techniques as further described below, and describe, among other features and benefits, example high-resolution compact snapshot hyperspectral imaging devices.

One example lightguide array device includes a plurality of lightguides configured as a three-dimensional structure having an input end and an output end, each lightguide extending from the input end to the output end and having an input facet that is configured to receive light at the input end of the three-dimensional structure and an output facet at the output end of the three-dimensional structure. Each lightguide includes a material that allows propagation of light from the input facet to the output facet without a cladding layer. The input facets of the plurality of lightguides form a first two-dimensional array at the input end of the three-dimensional structure with no spacing or a first spacing between each of the lightguides, the output facets of the plurality of lightguides form a second two-dimensional array at the output end of the three-dimensional structure with a second spacing between each of the lightguides that is larger than the spacing of the first three-dimensional array, and at least one of the input end or the output end is shaped as a curved surface.

### BRIEF DESCRIPTION OF THE DRAWINGS

FIG. 1 illustrates a snapshot hyperspectral imaging optical system that includes a lightguide array in accordance with an example embodiment.

FIG. 2 illustrates a snapshot hyperspectral imaging optical system that includes a lightguide array with curved input and output ends in accordance with an example embodiment.

FIGS. 3A to 3E illustrate example configurations of lightguide arrays in accordance with example embodiments.

FIG. 4 illustrates an example two-photon polymerization (TPP) printing process for a glass optics with liquid silica resin (LSR).

FIG. 5 illustrates scanning electron microscope (SEM) images of example 3D-printed lightguide arrays in accordance with example embodiments.

FIG. 6 illustrates a spectral imaging optical system that includes a lightguide array in accordance with another example embodiment.

FIG. 7 illustrates an example experimental hyperspectral imaging system in accordance with an example embodiment.

FIG. 8 illustrates a set of operations that can be carried out to produce a lightguide in accordance with an example embodiment.

### DETAILED DESCRIPTION

Snapshot hyperspectral imaging is an emerging imaging modality to obtain spectral information of a dynamic target in real time. A number of snapshot hyperspectral imaging technologies have been developed for various applications ranging from astronomy to agriculture and medical applications. These technologies include integral field imaging, image mapping, multi-aperture filtering, spectrally resolving detector array, coded aperture, computed tomography imaging, tunable echelle imager, and Fourier transform spectral imaging. Compared to other methods, integral field imaging method has a number of key advantages, such as ease of implementation with regular cameras, fewer computations, and lower cost.

The key in integral field imaging technology is how to sample the intermediate field. Pinhole arrays, faceted mirrors, fiber bundles, and lenslet arrays are commonly used to sample the field, each having unique properties and limitations. The pinhole array method is simple and low cost to implement, but the light efficiency and spatial resolution are two major issues, preventing this technique from being adopted in practical applications. Lenslet array approach partially addresses the light efficiency issue, but the spatial resolution is still the bottleneck. Faceted mirror approach is relatively difficult to implement as the faceted mirror is difficult to fabricate and there are some artifacts caused by the edges of the faceted mirrors. Fiber bundle approach is very straightforward, one end of the fiber array is arranged as compact as possible to sample the intermediate image, the other end of the fiber array is spatially arranged so that the spectral information can be separated in the detection sensor with dispersion element, such as prism or grating. The resolution is determined by the pitch of the fiber bundle in the input end. Due to the cladding of each fiber, the spatial resolution is still sacrificed.

Three-dimensional (3D) printing is an emerging fabrication method for precision optics, it is attractive due to its flexibility in building complex shapes through an additive process. Most of research in printing optics to date has focused on organic polymer or resin-based systems created using stereolithography (STL), projection microstereolithography (PμSL), direct ink writing (DIW), and two photon stereolithography (TPSL). Optical elements printed with organic polymer or resin through UV curing process have a number of limitations in hardness, transparency in ultraviolet (UV) and near infrared (NIR) regions, thermal resistance, chemical resistance and tenability. Another issue is that the printed part becomes yellowish as time goes on, and the transmission in short wavelengths is further degraded. Compared to optics made from optical polymers and optical silicones, inorganic glass optics are preferred for many applications because of excellent optical, chemical, and thermal properties.

The disclosed embodiments, among other features and benefits, relate to a high-resolution compact snapshot hyperspectral imaging devices that use 3D printed glass lightguide arrays. In some embodiments, the input end of the 3D printed lightguide array samples the intermediate image plane at high resolution since each lightguide can be printed as small as the pixel size of the digital sensor; the output end of the lightguide array is spatially arranged so that the spectrum of the light from each lightguide can be separated in the sensor with minimum crosstalk. In addition to the high spatial resolution, the devices produced according to the disclosed technology have a small footprint since the lightguide array can be printed to be very compact. Additionally, the input and output ends of the lightguide array can be printed to have different shapes, including having concave surfaces. With concave surfaces, the imaging optical systems can be simplified significantly as there is no need to correct field curvature, which is one of the driving factors for complex optical systems.

One of the goals of snapshot hyperspectral imaging is to obtain spectral information of the object with a single capture. To obtain high spatial and spectral resolution, due to the two-dimensional structure of the digital sensor it is necessary to re-arrange the images of the object points in the image plane so that their positions are sparsely located in the digital sensor. The pixels between adjacent points are reserved to capture spectral information.

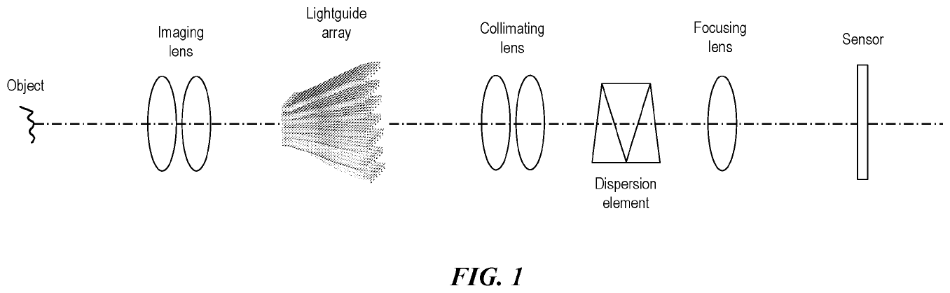

FIG. 1 illustrates a snapshot hyperspectral imaging optical system that includes a lightguide array in accordance with an example embodiment. Light from the object is received by the imaging lens. A lightguide array is positioned at the intermediate image plane to sample the light at its input end. A collimating lens receives light from the output end of the lightguide array and provides the collimated light to a dispersion element (e.g., a prism, a grating, etc.). The spectrally dispersed light is received by a focusing lens and is focused onto a pixelated detector. The object is imaged onto the input end (high spatial resolution) of the lightguide array. The output end of the lightguide array is arranged so that the light does not overlap in the sensor after the dispersion element and the focusing lens. The lightguide array in FIG. 1 includes flat input and output ends.

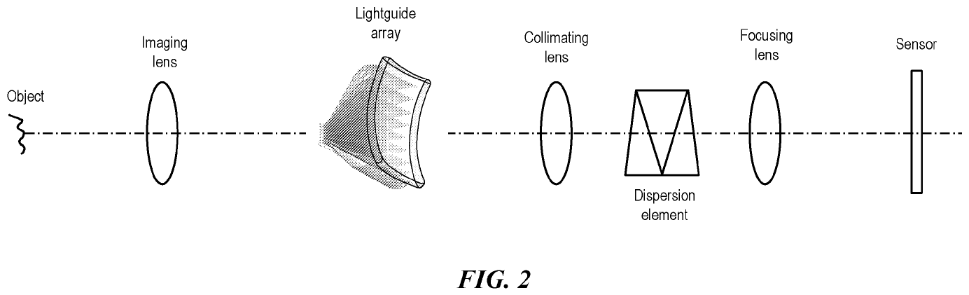

FIG. 2 illustrates a snapshot hyperspectral imaging optical system that includes a lightguide array with curved input and output ends in accordance with an example embodiment. That is, the object is imaged onto the input end (high spatial resolution) of the curved lightguide array via an imaging lens. The output end of the lightguide array is also curved and arranged so that the light will not overlap in the sensor after passing through the collimating lens, the dispersion element and the focusing lens. The main advantage with curved lightguide array is that the imaging lens and collimating lens can be simplified as there is no need to correct field curvature. For instance, in some embodiments, the curvature of the input facet can be designed to compensate for the field curvature of the imaging lens, and the curvature of the output end can be designed to compensate for the field curvature of the collimating lens. In some embodiments, the lightguide is designed first and then the imaging and collimating lens are selected (or designed) to eliminate field curvature.

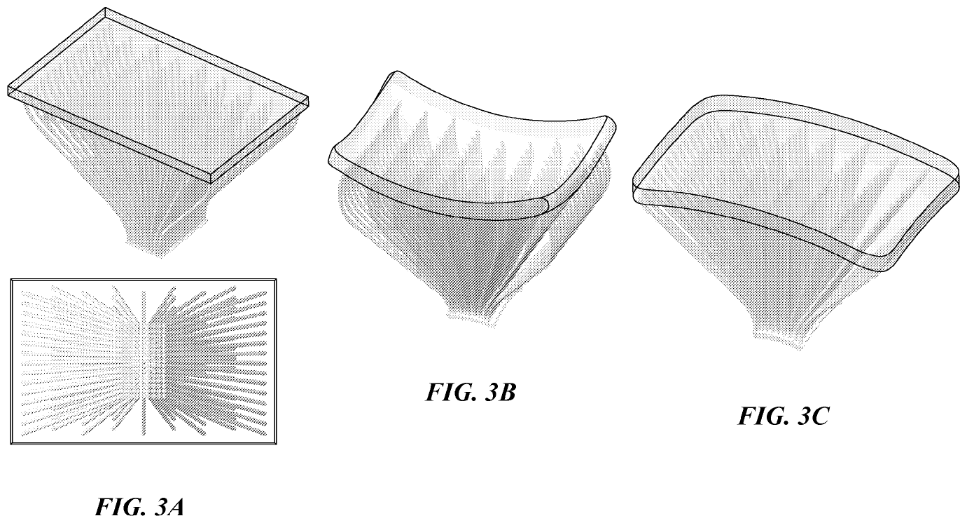

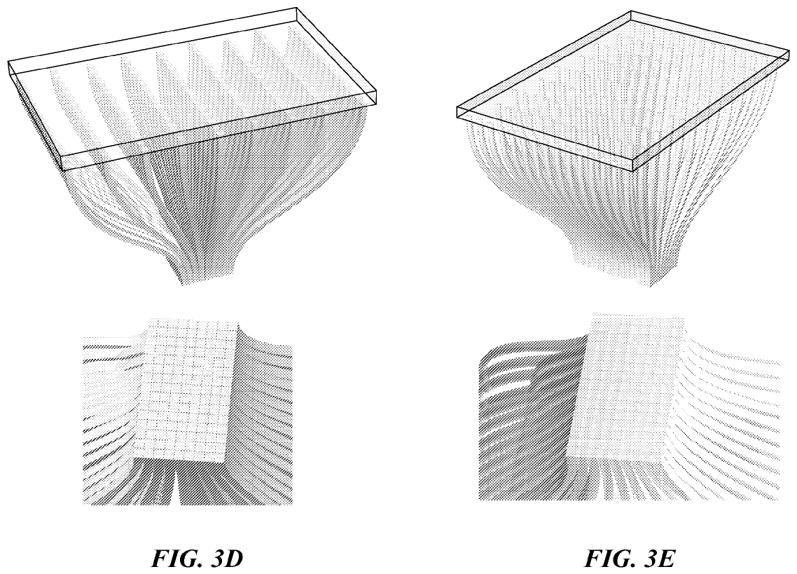

The function of the lightguide array is to transform the spatial distribution of the image formed by the optical system to the optimal distribution for obtaining spectral information with minimum crosstalk. The input and output surfaces of the lightguide array can have different surface shapes. FIGS. 3A to 3E are few of the lightguide arrays in accordance with example embodiments. Each individual lightguide in the lightguide arrays in FIG. 3A-3C has a circular input facet and a circular output facet. The lightguide array in FIG. 3A (which shows two different views of the same lightguide array) has flat input and flat output ends (or output sections). While the individual lightguides at the input end (or input section) of the lightguide array are as closely packed as possible to provide a high sampling rate, those lightguides are spatially separated (in both x-and y-directions) at the output end. This spatial separation (and staggering) of the output ends produces the necessary real estate to accommodate the detection of multiple spectral components for each lightguide that can fill-in the empty spaces, as well as to reduce or eliminate cross-talk between adjacent pixels. The separation of the lightguides at the output end and its geometry can be designed to accommodate a desired spectral resolution based on the geometry and resolution of a detector.

The lightguide array in FIG. 3B has a concave input surface and concave output surface. The concave input surface can simplify the imaging optics as there is no need to correct field curvature. It should be noted that one or both the input and output ends can be curved to simplify the design of the optical components that appear before and after the lightguide array, respectively. The lightguide array in FIG. 3C has a convex input surface and convex output surfaces. Lightguide arrays can also be fabricated with a flat input surface and a concave output surface, or vice versa. To maximize the light coupling efficiency, the input facet of the each lightguide and output facet of each lightguide should be positioned perpendicular to the input and output surfaces, respectively, as shown in FIGS. 3A-3B. That is each individual lightguide that extends from the input section to the output section can have a curvature along the path of the lightguide (see, e.g., the left most column of lightguides in FIG. 3C) to allow the end facet of the lightguide to be normal to the output surface.

One potential issue of the lightguide with circular shape (circular input facet of individual light guides) is that the fill-factor in the input surface is not close to 100%. The input light will lead in the spaces between the circular lightguide at the input end, reducing the image contrast and causing the spectral errors. To address this limitation, individual lightguides of the lightguide array can be fabricated with a square input facet as shown, for example, in the lightguide arrays in FIGS. 3D and 3E. The fill-factor at the input facet could be 100%, eliminating the light leakage. The output facet can be square shaped as shown in the example of FIG. 3D or circular shaped as shown in the example of FIG. 3E. The cross-section of the lightguides in FIG. 3E gradually transforms from square in the input end to circular in the output end. The input and output end surfaces of the square lightguide array could be flat or curved (e.g., concave) as well.

The function of the lightguide array is to transform the spatial distribution of pixels in the intermediate image in continuous mode to sparse mode. The lightguide array at the input end is arranged in a grid format (e.g., similar to the pixel layout in a monochromatic digital sensor) so that the intermediate image can be sampled with high resolution, and the hyperspectral image can be simply reconstructed in a grid format. The arrangement of the lightguide array in the output surface is optimized to efficiently utilize the pixels in the detector based on the required spectral resolution.

The diameter of each individual lightguide in the lightguide array should be small and the fill-factor in the input end of the lightguide should be sufficiently high for high resolution imaging. Notably, a multimode fiber is not suitable candidate for the disclosed lightguide arrays because the cladding layer reduces the fill-factor significantly. According to the disclosed embodiments, printed lightguide structures are produced to provide an ideal solution without a need for the cladding layer.

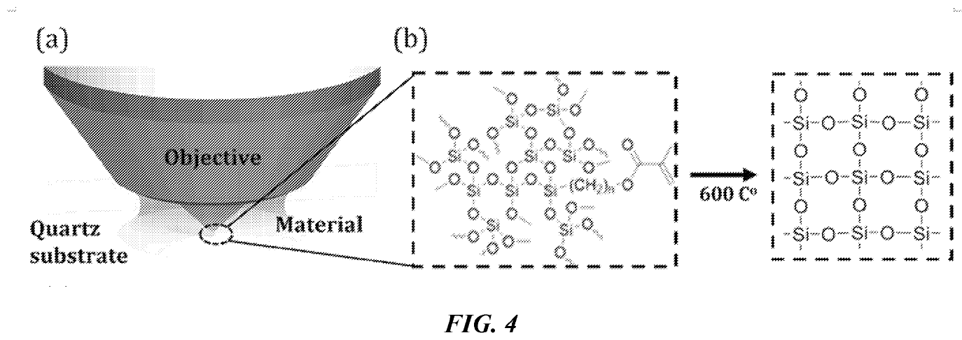

3D printing is attractive due to its flexibility in building complex shapes through an additive process. There are some reports that indicate the use polymeric materials to print organic optics via additive manufacturing. However, organic optics printed by polymer-based components are limited in practical applications due to their poor thermal stability, low transmission in short wavelengths, and low refractive indices. Glass optics are preferred because of better optical, chemical, thermal, and mechanical properties. In the past few years, we have developed a two-photon polymerization (TPP) printing method with a solvent-free, pre-condensed liquid silica resin (LSR) for fabricating micro glass optics with relatively complex structures. Transparent glass optics can be obtained after thermal treatment at 600° C. in the air. The solvent-free LSR was synthesized based on acid-catalyzed polymerization of tetramethoxysilane (TMOS) together with sub-stoichiometric amount of water (water solution) and 6.5 mol % of methacryloxymethyltrimethoxysilane (MMTS) as photocurable moiety. FIG. 4 shows the TPP printing process for glass optics with LSR. In panel (a), a schematic diagram illustrates the focusing of the laser light to a small spot to cure LRS locally in the focal point and in panel (b), the pyrolysis process of the cured structure is shown. The lightguide printed in accordance with the disclosed embodiments can have a diameter that is as small as 2 μm.

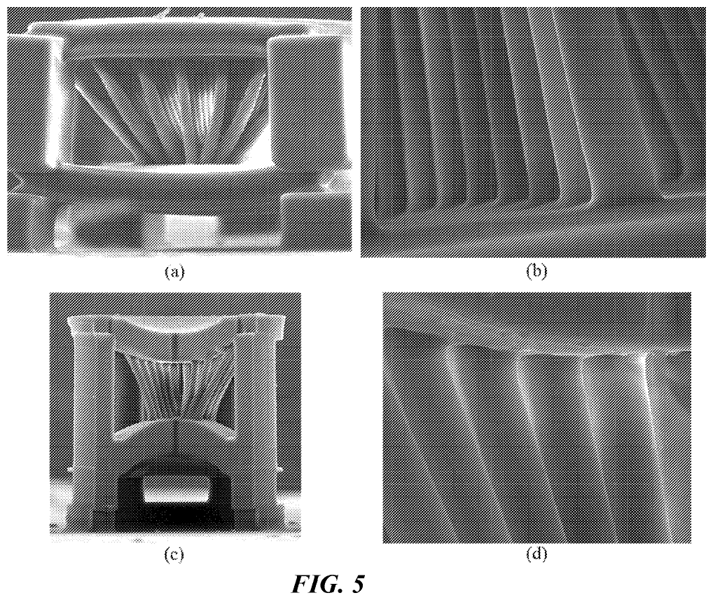

To demonstrate the capability of the printing system and materials, we have printed lightguide arrays with different input and output surface shapes, as shown in FIG. 5. Panel (a) is the printed lightguide array with convex input and output surfaces, and panel (b) is the SEM image of the individual lightguide in the input surface. As shown in the FIG. 5, the lightguide has smooth surfaces, ensuring the efficiency of total-internal-reflection (TIR). Panel (c) is the SEM image of the printed lightguide array with concave input and output surfaces, while panel (d) shows the details of the individual lightguide in the output surface.

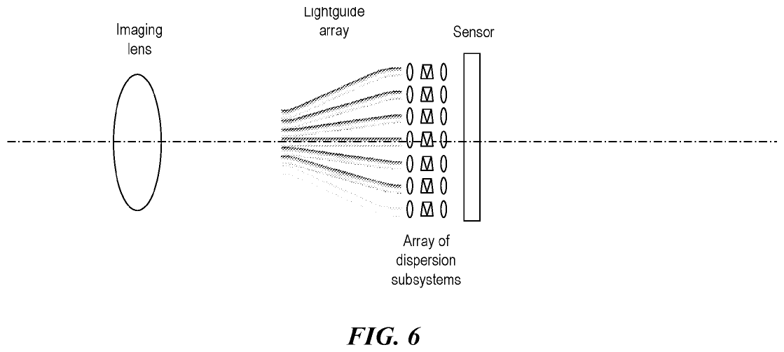

FIG. 6 illustrates a spectral imaging optical system that includes a lightguide array in accordance with another example embodiment. In this configuration, similar to prior configurations, light from an object is received at the input of the lightguide array via an imaging lens. An array of dispersion subsystems, including an array of collimation lenses (first set of lenses in the dispersion subsystem), an array of dispersion elements and an array of focusing lenses ((first set of lenses in the dispersion subsystem) are used. That is, each lightguide has its own miniature dispersion subsystem. Such a system is an ultracompact spectral imaging system.

In some example embodiments, arrays of up to 1000 by 1000 elements can be produced. The dimension of each light guide could be as small as 2 μm diameter or square. For example, an input end of the lightguide array can be shaped as a rectangular array having 1,000,000 lightguides. The current state of the art CMOS sensors have a pitch of about 1-5 μm.

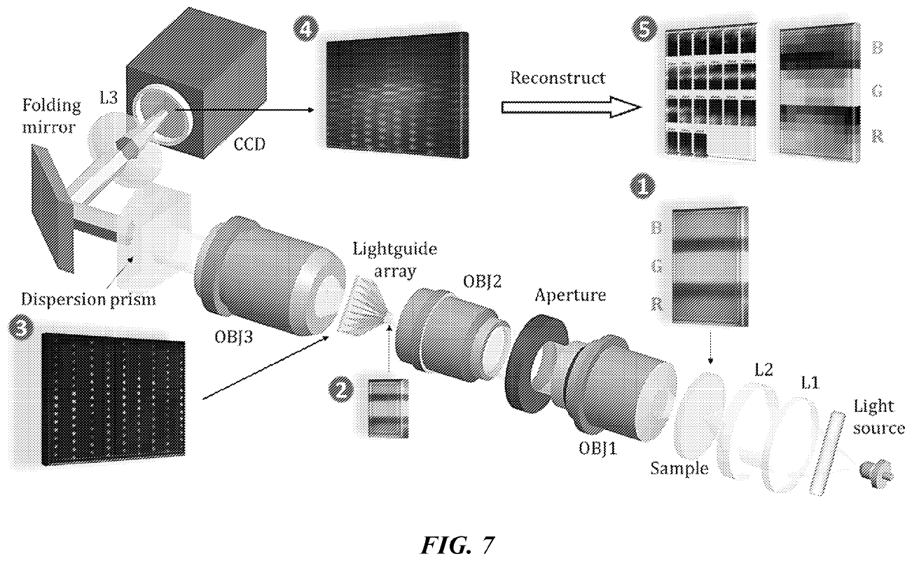

FIG. 7 shows an example experimental hyperspectral imaging system in accordance with an example embodiment. In FIG. 7, LS is a white light source; L1 and L2 are the lenses for illumination; OBJ1, OBJ2, and OBJ3 are microscope objectives; OBJ1 and OBJ2 are used to relay the image of the sample; AP is the aperture to adjust the numerical aperture (NA); OBJ3 works for the imaging lens; P1 is the dispersion prism assembly; M1 is a folding mirror; and L3 is the imaging lens. 1. \textcircled{2} is the image of the sample \textcircled{1} on the input surface of the lightguide array; \textcircled{4} is the dispersed image of the image \textcircled{3} on the output surface of the lightguide array; and \textcircled{5} is the reconstructed hyperspectral image.

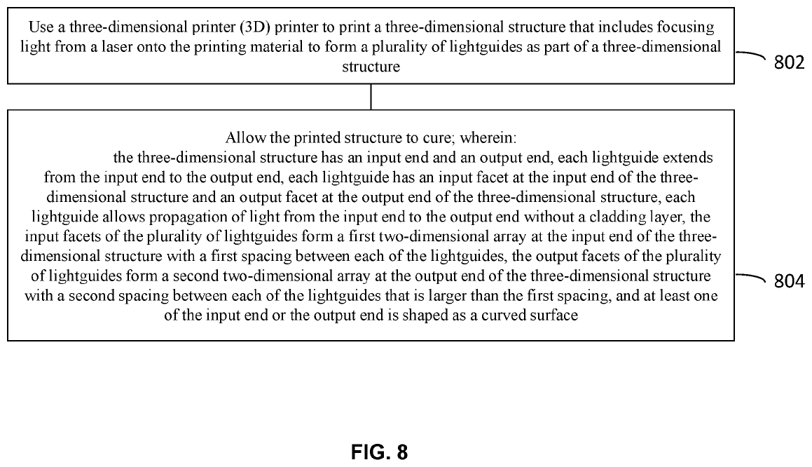

FIG. 8 illustrates a set of operations that can be used for producing a lightguide in accordance with an example embodiment. At 802, a three-dimensional printer (3D) printer is used to print a three-dimensional structure that includes focusing light from a laser onto the printing material to form a plurality of lightguides as part of a three-dimensional structure. At 804, the printed structure is allowed to cure. The three-dimensional structure has an input end and an output end, each lightguide extends from the input end to the output end, each lightguide has an input facet at the input end of the three-dimensional structure and an output facet at the output end of the three-dimensional structure, each lightguide allows propagation of light from the input end to the output end without a cladding layer, and the input facets of the plurality of lightguides form a first two-dimensional array at the input end of the three-dimensional structure with a first spacing between each of the lightguides. Additionally, the output facets of the plurality of lightguides form a second two-dimensional array at the output end of the three-dimensional structure with a second spacing between each of the lightguides that is larger than the first spacing, and at least one of the input end or the output end is shaped as a curved surface.

One aspect of the disclosed embodiments relates to a lightguide array device for sampling an intermediate image plane of an optical system. The lightguide array devices includes a plurality of lightguides configured as a three-dimensional structure having an input end and an output end. Each lightguide extends from the input end to the output end and has an input facet that is configured to receive light at the input end of the three-dimensional structure and an output facet at the output end of the three-dimensional structure. Each lightguide comprises a material that allows propagation of light from the input facet to the output facet without a cladding layer. The input facets of the plurality of lightguides form a first two-dimensional array at the input end of the three-dimensional structure with no spacing or a first spacing between each of the lightguides, and the output facets of the plurality of lightguides form a second two-dimensional array at the output end of the three-dimensional structure with a second spacing between each of the lightguides that is larger than the spacing of the first three-dimensional array, and at least one of the input end or the output end is shaped as a curved surface.

In one example embodiment, the input end is shaped as a curved surface. In another example embodiment, the output end is shaped as a curved surface. In yet another example embodiment, both the input end and the output end are shaped as curved surfaces. In still another example embodiment, either the input end or the output end is shaped as a plane surface. In another example embodiment, the curved surface is a concave surface or a convex surface.

According to another example embodiment, the input end has a curvature that is designed to correct a field curvature of one or more optical components positioned before the lightguide array in the optical system. In one example embodiment, the output end has a curvature that is designed to correct a field curvature of one or more optical components positioned after the lightguide array in the optical system. In another example embodiment, the input facet of each lightguide is square shaped. In still another example embodiment, the input facet of each lightguide is circular shaped. In yet another example embodiment, the output facet of each lightguide is square shaped. In another example embodiment, the output facet of each lightguide is circular shaped.

In another example embodiment, the input end is perpendicular to the surface of the input end. In yet another example embodiment, the output facet of each lightguide is perpendicular to the surface of the output end. In still another example embodiment, the material of each of the lightguides is glass. In another example embodiment, each of the lightguides in the first two-dimensional array contact each other, and a diameter of each of the lightguides is as small as 2 μm. In one example embodiment, the three-dimensional structure includes up to one million lightguides.

In another example embodiment, the first two-dimensional array is one of a square a rectangular or a circular array. In yet another example embodiment, one or more lightguides of the lightguide array device has a curvature curved along a length of the lightguide. In still another example embodiment, a direction of propagation of light in the lightguide array device is in z-direction, and wherein the lightguides are separated from one another in the second two-dimensional array at the output end of the three-dimensional structure in both x-and y-directions at distances that are greater than x-and y-direction separations of the lightguides in the first two-dimensional array at the input of the three-dimensional structure. In one example embodiment, the input facets of the lightguides in the second two-dimensional array at the output of the three-dimensional structure are arranged in a staggered fashion.

According to another example embodiment, the lightguide array device is positioned in the optical system, and the optical system includes an imaging lens positioned to receive light from an object of interest. The lightguide array device positioned in the optical system to sample light received from the imaging lens at an intermediate image plane. The optical system includes one or more collimating lenses positioned to receive light output from the lightguide array, one or more dispersion elements positioned to receive light from the one or more collimating lenses, and one of more focusing lenses positioned to receive spectrally dispersed light from the one or more dispersion elements, wherein the focusing lens is positioned to direct light to an image plane. In another example embodiment, the optical system includes a pixelated detector positioned at the image plane. In yet another example embodiment, the optical system includes a plurality of collimating lenses, a plurality of dispersion elements and a plurality of focusing lenses configured as corresponding collimating lens, dispersion element and focusing lens arrays, wherein each set of collimating lens, dispersion element and focusing lens elements of said arrays is configured to receive light from a corresponding individual lightguide.

Another aspect of the disclosed embodiments relates to a lightguide array device for sampling an intermediate image plane of an optical system. The lightguide array devices includes a plurality of lightguides configured as a three-dimensional structure having an input end and an output end, each lightguide extending from the input end to the output end and having an input facet at the input end of the three-dimensional structure and an output facet at the output end of the three-dimensional structure, each lightguide comprising a material that allows propagation of light from the input end to the output end without a cladding layer. The input facets of the plurality of lightguides form a first two-dimensional array at the input end of the three-dimensional structure with no spacing or a first spacing between each of the lightguides, the output facets of the plurality of lightguides form a second two-dimensional array at the output end of the three-dimensional structure with a spacing between each of the lightguides that is larger than the first spacing that is greater than the spacing between the lightguides of the first two-dimensional array, and the material of each lightguide is three-dimensional (3D) printed glass.

Another aspect of the disclosed embodiments relates to a lightguide array device for sampling an intermediate image plane of an optical system. The lightguide array device includes a plurality of lightguides configured as a three-dimensional structure having an input section and an output section, each lightguide extending from the input section to the output section and having an input facet at the input section of the three-dimensional structure and an output facet within the output section of the three-dimensional structure, and each lightguide comprising a material that allows propagation of light from the input section to the output section without a cladding layer. The input facets of the plurality of lightguides form a first two-dimensional array at the input section of the three-dimensional structure with no spacing or a first spacing between each of the lightguides, and the output facets of the plurality of lightguides form a second two-dimensional array at the output section of the three-dimensional structure with a spacing between each of the lightguides that is larger than the spacing between the lightguides of the first three-dimensional array. Additionally, the output section includes a plurality of collimating lenses, a plurality of dispersion elements and a plurality of focusing lenses configured as corresponding collimating lens, dispersion element and focusing lens arrays, and wherein each set of collimating lens, dispersion element and focusing lens elements of said arrays is configured to receive light from a corresponding individual lightguide at the output section.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

1. A lightguide array device for sampling an intermediate image plane of an optical system, comprising:
a plurality of lightguides configured as a three-dimensional structure having an input end and an output end, each lightguide extending from the input end to the output end and having an input facet that is configured to receive light at the input end of the three-dimensional structure and an output facet at the output end of the three-dimensional structure, each lightguide comprising a material that allows propagation of light from the input facet to the output facet without a cladding layer, wherein:
the input facets of the plurality of lightguides form a first two-dimensional array at the input end of the three-dimensional structure with no spacing or a first spacing between each of the lightguides,
the output facets of the plurality of lightguides form a second two-dimensional array at the output end of the three-dimensional structure with a second spacing between each of the lightguides that is larger than the spacing of the first three-dimensional array, and
at least one of the input end or the output end is shaped as a curved surface.

2. The lightguide array of claim 1, wherein one or both of the input end and the output end is shaped as a curved surface.

3-4. (canceled)

5. The lightguide array device of claim 1, wherein either the input end or the output end is shaped as a plane surface.

6. The lightguide array device of claim 1, wherein the curved surface is a concave surface or a convex surface.

7. The lightguide array device of claim 1, wherein the input end has a curvature that is designed to correct a field curvature of one or more optical components positioned before the lightguide array in the optical system.

8. The lightguide array of claim 1, wherein the output end has a curvature that is designed to correct a field curvature of one or more optical components positioned after the lightguide array in the optical system.

9. The lightguide array device of claim 1, wherein the input facet of each lightguide has (a) a square shape, or (b) circular shape.

10. (canceled)

11. The lightguide array device of claim 1, where the output facet of each lightguide has (a) a square shape, or (b) circular shaped.

12. (canceled)

13. The lightguide array device of claim 1, wherein the input end is perpendicular to the surface of the input end, and the output facet of each lightguide is perpendicular to the surface of the output end.

14. (canceled)

15. The lightguide array device of claim 1, wherein the material of each of the lightguides is glass.

16. The lightguide array device of claim 1, wherein each of the lightguides in the first two-dimensional array contact each other, and a diameter of each of the lightguides is as small as 2 μm.

17. (canceled)

18. The lightguide array of claim 1, wherein the first two-dimensional array is one of a square, a rectangular or a circular array.

19. The lightguide array device of claim 1, wherein one or more lightguides of the lightguide array device has a curvature along a length of the lightguide.

20. The lightguide array device of claim 1, wherein a direction of propagation of light in the lightguide array device is in z-direction, and wherein the lightguides are separated from one another in the second two-dimensional array at the output end of the three-dimensional structure in both x-and y-directions at distances that are greater than x-and y-direction separations of the lightguides in the first two-dimensional array at the input of the three-dimensional structure.

21. The lightguide array device of claim 1, wherein the input facets of the lightguides in the second two-dimensional array at the output of the three-dimensional structure are arranged in a staggered fashion.

22. The lightguide array of claim 1, wherein lightguide array device is positioned in the optical system, the optical system including:
an imaging lens positioned to receive light from an object of interest,
the lightguide array device positioned to sample light received from the imaging lens at an intermediate image plane,
one or more collimating lenses positioned to receive light output from the lightguide array device,
one or more dispersion elements positioned to receive light from the one or more collimating lenses, and
one of more focusing lenses positioned to receive spectrally dispersed light from the one or more dispersion elements, wherein the focusing lens is positioned to direct light to an image plane.

23. The lightguide array device of claim 22, wherein the optical system includes a pixelated detector positioned at the image plane.

24. The lightguide array of device claim 22, comprising a plurality of collimating lenses, a plurality of dispersion elements and a plurality of focusing lenses configured, respectively as a collimating lens array, a dispersion element array and a focusing lens array, wherein each set of collimating lens, dispersion element and focusing lens elements of said arrays is configured to receive light from a corresponding individual lightguide.

25. A lightguide array device for sampling an intermediate image plane of an optical system, comprising:
a plurality of lightguides configured as a three-dimensional structure having an input end and an output end, each lightguide extending from the input end to the output end and having an input facet at the input end of the three-dimensional structure and an output facet at the output end of the three-dimensional structure, each lightguide comprising a material that allows propagation of light from the input end to the output end without a cladding layer, wherein:
the input facets of the plurality of lightguides form a first two-dimensional array at the input end of the three-dimensional structure with no spacing or a first spacing between each of the lightguides,
the output facets of the plurality of lightguides form a second two-dimensional array at the output end of the three-dimensional structure with a spacing between each of the lightguides that is larger than the first spacing that is greater than the spacing between the lightguides of the first two-dimensional array, and
the material of each lightguide is three-dimensional (3D) printed glass.

26. A method for producing a lightguide, comprising:
using a three-dimensional printer (3D) printer to print a three-dimensional structure that includes focusing light from a laser onto the printing material to form a plurality of lightguides as part of a three-dimensional structure; and
allowing the printed structure to cure; wherein:
the three-dimensional structure has an input end and an output end, each lightguide extends from the input end to the output end, each lightguide has an input facet at the input end of the three-dimensional structure and an output facet at the output end of the three-dimensional structure, each lightguide allows propagation of light from the input end to the output end without a cladding layer, the input facets of the plurality of lightguides form a first two-dimensional array at the input end of the three-dimensional structure with a first spacing between each of the lightguides,
the output facets of the plurality of lightguides form a second two-dimensional array at the output end of the three-dimensional structure with a second spacing between each of the lightguides that is larger than the first spacing, and
at least one of the input end or the output end is shaped as a curved surface.

27. (canceled)
